(19) United States
(12) Patent Application Publication
(10) Pub. No.: US 2018/0337550 A1
(43) Pub. Date: Nov. 22, 2018

(54) SYSTEMS, APPARATUS, AND METHODS FOR SAFE ENERGY STORAGE

(71) Applicant: Ioxus, Inc., Oneonta, NY (US)

(72) Inventors: Joseph D. Agrelo, Ballston Spa, NY (US); Daniel A. Patsos, Canajoharie, NY (US)

(73) Assignee: Ioxus, Inc., Oneonta, NY (US)

(21) Appl. No.: 15/983,428

(22) Filed: May 18, 2018

Related U.S. Application Data
(60) Provisional application No. 62/507,998, filed on May 18, 2017.

(51) Int. Cl. H02J 7/34; H02J 7/00; H02J 9/06; H01G 11/08; H01G 11/10; H01G 11/52; H01G 11/54; H01G 11/82; H01G 11/22; H02H 7/16; H02H 7/18

(52) U.S. Cl. CPC H02J 7/345; H02J 7/0031; H02J 9/061; H01G 11/08; H01G 11/10; H01G 11/52; H02J 2007/0037; H01G 11/82; H01G 11/22; H02H 7/16; H02H 7/18; H02J 2009/068; H01G 11/54

(57) ABSTRACT

Systems, apparatus, and methods are disclosed for operating a system comprising an energy storage device electrically couplable to an external device with a first terminal and a second terminal and a switch device disposed between the energy storage device and the first terminal and/or the second terminal such that actuating the switch device either disconnects the energy storage device from the first terminal and/or the second terminal so as to prevent at least one of discharging energy from the energy storage device to the external device and charging the energy storage device with energy from the external device, or connects the energy storage device to the first terminal and the second terminal so as to allow at least one of supplying energy to the external device from the energy storage device and charging the energy storage device with energy from the external device.

### CROSS-REFERENCE TO RELATED APPLICATION

This application claims the priority benefit, under 35 U.S.C. 119(e), of U.S. Application No. 62/507,998, entitled “SYSTEMS, APPARATUS, AND METHODS FOR SAFE ENERGY STORAGE” and filed on May 18, 2017, the disclosure of which is hereby incorporated by reference in its entirety.

### TECHNICAL FIELD

The present disclosure relates generally to systems, apparatus, and methods for improving the safety of energy storage devices, and more particularly to electrical disconnections to render the energy storage devices electrically safe.

### BACKGROUND

The general trend in developing energy storage devices is to increase the energy density and the power density of the devices so as to extend cycle life (e.g., smartphone battery life) and to support applications with high power requirements (e.g., electric vehicles). Increases in energy and power density also raise safety concerns. An accidental fault or short circuit of these energy storage devices may cause an electrical explosion or discharge of a large amount of energy within a short period of time, thereby threatening not only the energy storage device but also nearby individuals (e.g., maintenance personnel) and property. For example, an electrical arc flash event, during which temperatures can reach or exceed 35,000° F. (i.e., hotter than the surface of the sun), may cause substantial damage, fire, injury, and possibly even death. Existing safety measures are burdensome (e.g., time-consuming and expensive) or impractical (e.g., reducing energy and power density) and therefore fail to address these safety hazards satisfactorily.

### SUMMARY

Systems, apparatus, and methods are disclosed for operating an energy storage device electrically coupleable to an external device through a first terminal and a second terminal having a switch device disposed within a housing between the energy storage device and the first terminal and/or the second terminal. In some embodiments, actuating the switch device disconnects the energy storage device from the first terminal and/or the second terminal so as to prevent at least one of discharging energy from the energy storage device to the external device and charging the energy storage device with energy from the external device. In some embodiments, actuating the switch device connects the energy storage device to the first terminal and/or the second terminal so as to allow for at least one of supplying the external device with energy from the energy storage device and charging the energy storage device with energy from the external device.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic illustration of an energy storage system including a safety switch in accordance with some embodiments.

FIG. 2 is a schematic illustration of an energy storage system including a safety switch and a controller in accordance with some embodiments.

FIG. 3 is a schematic illustration of an energy storage system including a safety switch controlled by a microcontroller in accordance with some embodiments.

FIG. 4 is a schematic illustration of an energy storage system including a safety switch and a trickle charge switch in accordance with some embodiments.

### DETAILED DESCRIPTION

The present disclosure describes systems, apparatus, and methods for improving the safety of energy storage devices, and more particularly to safety disconnections for energy storage devices.

Increases in the energy and power density of energy storage devices also raise safety concerns. For example, ultracapacitors have the advantage of fast charging and discharging of a large amount of energy in a short amount of time. However, this advantage may cause a safety hazard in the case of an accidental short circuit (i.e., when current travels along an unintended path with a very low electrical impedance), which can produce, for examples, arc flashes. Arc flashes are usually the result of human error, and 65 percent of arc flashes occur when an operator is working on the switchgear. Traditional attempts to protect operators from arc flashes includes equipping them with personal protective equipment, which may be burdensome and inconvenient to the operator, or by replacing them with remote operators and/or robots, which may be impractical or too expensive. Another way to protect operators from arc-flash hazards is to de-energize the ultracapacitor during access and/or maintenance. In some industrial applications, this step may take significant coordination or is simply not feasible. Therefore, it is desirable to provide more efficient safety protection for energy storage devices.

In response to challenges in addressing safety hazards in energy storage systems, technologies described herein employ a safety switch between the energy storage element (e.g., internal electrodes in ultracapacitors) and any external terminals that are exposed to the surrounding environment. In some embodiments, when personnel are required work nearby an energy storage device, the safety switch may be turned off manually so as to isolate the energy storage element from accidental short circuit. In some embodiments, the switch can be configured to automatically turn off in response to changes of operation parameters such as a surge of electric current or a substantial drop in voltage. These technologies are convenient, cost-effective, and adaptable to various types of energy storage devices.

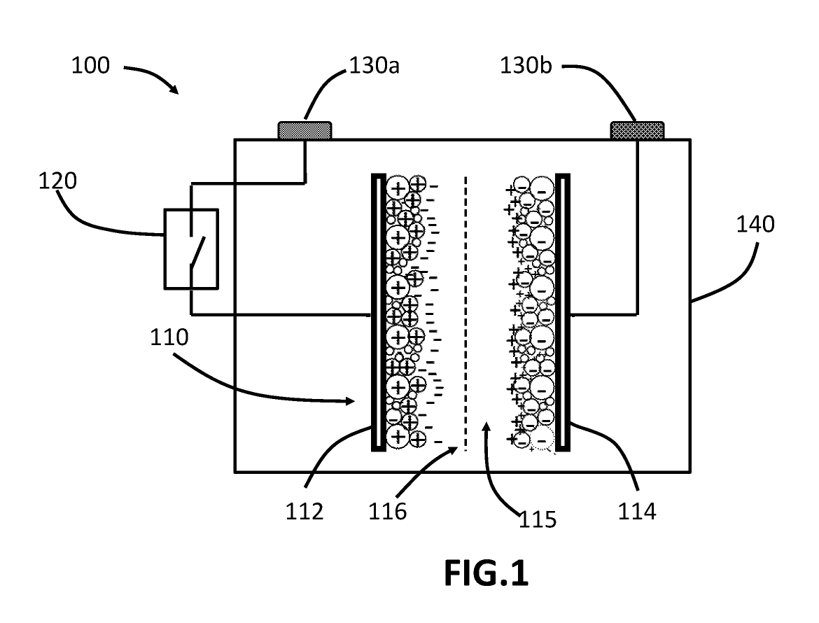

FIG. 1 illustrates a system 100 that can address, at least partially, safety hazards associated with electrical energy storage in accordance with some embodiments. In FIG. 1, the system 100 includes an energy storage device (e.g., a battery, ultracapacitor, etc.) 110, which stores electrical energy. As shown in FIG. 1, the energy storage device 110 may include a positive electrode 112, a negative electrode 114 (collectively the internal electrodes 112, 114), an electrolyte 115 (also referred to as a dielectric layer or dielectric material) disposed in a space defined by the positive electrode 112 and the negative electrode 114, and a separator 116 disposed in the electrolyte 115 for allowing diffusion of ions but not electrons. In addition to the energy storage device 110, the system 100 includes a safety switch 120 and a pair of electrodes 130a and 130b (also referred to as terminals 130a and 130b). The energy storage device 110 is substantially enclosed in a housing 140 and is coupled to the pair of electrodes 130a and 130b, which are external to the housing 140 and thus collectively referred to as external electrodes or terminals 130. The terminals 130 act as an interface to couple the system 100 to deliver electrical energy to an external device (e.g., during discharging) or receive electrical energy from an external device (e.g., during charging). The terminals 130 are coupled to the energy storage device 110 via the safety switch 120, which can be internal to the housing 140 and/or external to the housing 140 so as to allow access for an operator to control the safety switch 120. By turning off the safety switch 120, an operator can disconnect the energy storage device 110 from the terminals 130 and can thereby safely work with the system 100 or in the vicinity of the system 100. In some embodiments, the system 100 includes a safety switch 120 disposed inside the housing 140 and is configured to be automatically actuated or initiated in response to a command from a processor or controller.

### Safety Switches

Various types of switches may be used to construct the safety switch 120 shown in FIG. 1. In some embodiments, the safety switch 120 includes a toggle switch actuated by a lever angled in one of two or more positions. The toggle switch may rest in any of its lever positions or may have an internal spring mechanism that returns the lever to a certain position, thereby allowing for “momentary” operation.

In some embodiments, the safety switch 120 includes a pushbutton switch. The pushbutton switch may be a two-position device actuated with a button that is pressed and released. The pushbutton switch may have an internal spring mechanism for returning the button to a certain position (e.g., its “out” or “un-pressed” position) for momentary operation. In some embodiments, the pushbutton switch may latch alternately on or off with every push of the button. In other embodiments, the pushbutton switch stays in a certain position (e.g., its “in” or “pressed” position) until the button is pulled back out. In some embodiments, the pushbutton switch requires a continuous hold (i.e., in “pressed” position) of a finite period of time to close the switch so as to avoid accidental triggering of the switch. The finite period of time may be about 1 second to about 30 seconds (e.g., about 2 seconds, about 5 seconds, about 10 seconds, or about 15 seconds).

In some embodiments, the safety switch 120 includes a selector switch that can be actuated with a rotary knob or lever to select one of two or more positions. The selector switch may rest in any of its positions or may contain an internal spring return mechanism for momentary operation.

In some embodiments, the safety switch 120 includes a joystick switch that can be actuated by a lever free to move in more than one axis of motion. One or more of several switch contact mechanisms may be actuated depending on which way(s) the lever is pushed. In some embodiments, one or more of several switch contact mechanisms are actuated depending on how far the lever is pushed in any one direction.

In some embodiments, the safety switch includes a power Metal-Oxide Semiconductor Field Effect Transistor (MOSFET), which is a three-terminal silicon device. The power MOSFET switch may function by applying a signal to a gate that controls current conduction between a source and a drain. The current conduction capabilities may be up to several tens of amperes, with breakdown voltage ratings of about 10 V to over 1000 V.

In some embodiments, the safety switch includes an insulated gate bipolar transistor (IGBT), which is a three-terminal power semiconductor. IGBTs are known for high efficiency and modest switching speeds.

In some embodiments, the safety switch includes silicon carbide (SiC) power semiconductors, which may reduce on-resistance to up to about two orders of magnitude compared with existing silicon devices.

In some embodiments, the safety switch includes a gallium nitride (GaN) device grown on top of a silicon substrate. A GaN device may behave similar to a silicon MOSFET. In some embodiments, a GaN device is a GaN transistor. A positive bias on the gate relative to the source causes the device to turn on. When the bias is removed from the gate, the electrons under the gate are dispersed into the GaN, recreating the depletion region, and once again, giving the device the capability to block voltage.

The default state of the safety switch may be either on or off. In some embodiments, the safety switch is set to be in the connected state (“ON” state) unless an operator affirmatively disconnects it. For example, a ultracapacitor cell may continuously power the external devices unless and until an operator intervenes. In some embodiments, the safety switch is set to be in the disconnected state (“OFF” state) unless an operator affirmatively connects it.

In some embodiments, the safety switch is automatically disconnected when certain operation condition of the energy storage device occurs. For example, a system may include a thermometer to monitor the operation temperature of an energy storage device (e.g., a ultracapacitor cell). If the temperature rises over a threshold temperature, the safety switch can automatically disconnect so as to protect the energy storage device or the external device. In another example, the electric current flowing through the wires connecting internal electrodes and/or terminals is monitored such that if the current rises over a threshold current, the safety switch automatically disconnects.

Energy storage devices that can be used with some embodiments, include, but are not limited to, ultracapacitor(s), ultra-capacitor(s), supercapacitor(s), and EDLC(s) (electrochemical double layer capacitors), the terms of which are all used interchangeably within the present disclosure. As described herein, the energy storage device can include one or more ultracapacitor cells disposed within housing.

Energy storage devices that can also be used with some embodiments include, but are not limited to, primary batteries, lithium-ion capacitors (LiCs), lithium ion batteries (LiBs), secondary (rechargeable) batteries, wet cells, dry cells, galvanic cells, electrolytic cells, fuel cells, flow cells, voltaic piles, biological batteries, leak acid cells, Daniell cells, superconducting magnetic storage systems, and/or capacitors.

It is worth noting that FIG. 1 shows only one ultracapacitor cell 110 for illustration purposes only. In practice, the ultracapacitor system 100 may include multiple ultracapacitor cells. In some embodiments, the ultracapacitor system 100 includes an array of ultracapacitor cells connected, for example, in series. In some embodiments, the ultracapacitor 100 includes an array of ultracapacitor cells connected in parallel with all the positive electrodes connected to the external positive terminal 130a and all the negative electrodes connected to the external negative terminal 130b. In some embodiments, the ultracapacitor system 100 includes multiple ultracapacitor cells connected in a hybrid configuration, in which part of the cells are connected in series and part of the cells are connected in parallel.

Systems with a Safety Switch and a Controller

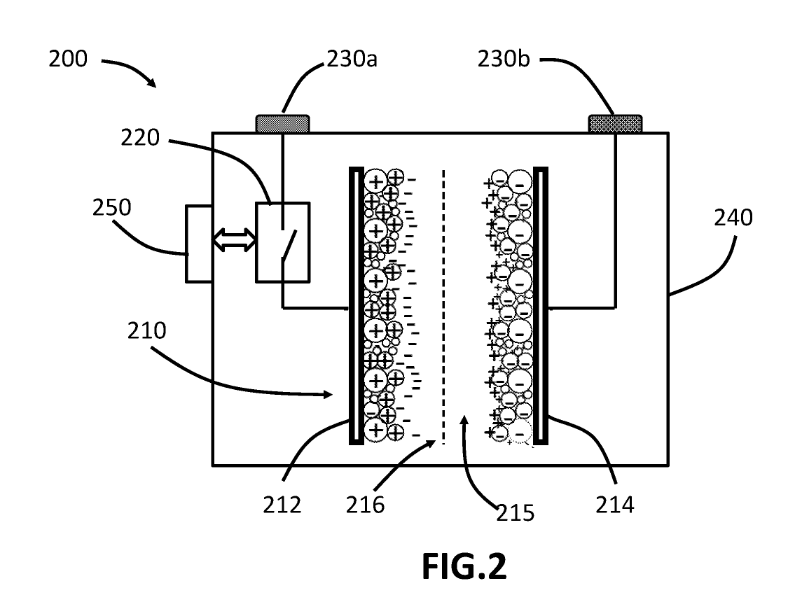

FIG. 2 illustrates a schematic of a ultracapacitor system 200, in accordance with some embodiments, including a ultracapacitor cell 210 with a positive electrode 212, a negative electrode 214, an electrolyte 215 disposed in the space defined by the positive electrode 212 and the negative electrode 214, and a separator 216 disposed in the electrolyte 215 allowing diffusion of ions but not electrons. The ultracapacitor system 200 also includes a safety switch 220 coupling the ultracapacitor cell 210 to a pair of external terminals 230a and 230b (collectively referred to as external electrodes 230 or terminals 230). The ultracapacitor cell 210 and the safety switch 220 are substantially enclosed in a housing 240. A controller 250, disposed outside the housing 240 and operably coupled to the safety switch 220, can be used to control the safety switch 220.

In some embodiments, the controller 250 is coupled to the safety switch 220 via wires. In some embodiments, the controller 250 is coupled to the safety switch 220 via wireless communication, including, but not limited to, radio frequency (RF) communication, WiFi, Bluetooth, 3G, 4G, infrared communication, Internet, or any other means known in the art. In some embodiments, the safety switch 220 is controlled by the controller 250 via a relay so as to protect the operator from potential electric shock.

In some embodiments, the controller 250 is affixed to a wall of the housing 240. In other embodiments, the controller 250 is removable and/or separate from the ultracapacitor cell 210. The controller 250 may be mobile or portable. For example, an operator may remove and/or carry the controller 250 separate from the ultracapacitor cell 210, yet be able to control and interact with the ultracapacitor system 200 when working in the vicinity of the ultracapacitor cell 210. In these examples, the controller 250 may be coupled to the safety switch 220 via either wired or wireless communication.

In some embodiments, the safety switch 220 can be configured to provide enhanced safety during operation via one or more of the following features. In some embodiments, the safety switch 220 is integrated within the housing 240 that may require certain authorization to open. Therefore, the safety switch 220 can only be disabled by authorized personnel. In some embodiments, the safety switch 200 may only be actuated via wireless signals from the controller 250. This feature can avoid inadvertent actuation of the safety switch 220. Integrating the safety switch 220 within the housing 240 at the time of manufacturing can provide the advantages of a lower cost and a smaller form factor than adding a safety switch afterwards. In this manner, the housing 240 isolates and seals both the ultracapacitor cell 210 and safety switch 220 from the external environment.

In some embodiments, the safety switch 220 that is substantially enclosed within the housing and does not include an external actuator to disconnect the electrical connection between the ultracapacitor cell 210 and at least one of a first terminal 230a and a second terminal 230b. In other words, the safety switch 220 that integrated within the housing 240 cannot be disconnected or connected by a mechanical or an electrical actuator external to the housing 240. In these embodiments, the safety switch can be engaged or disengaged by a wireless signal transmitted to controller 250 that is located within the housing 240. These embodiments prevents unauthorized operators that do not have access a wireless transmitter from accidentally or intentionally engaging or disengaging the safety switch 220.

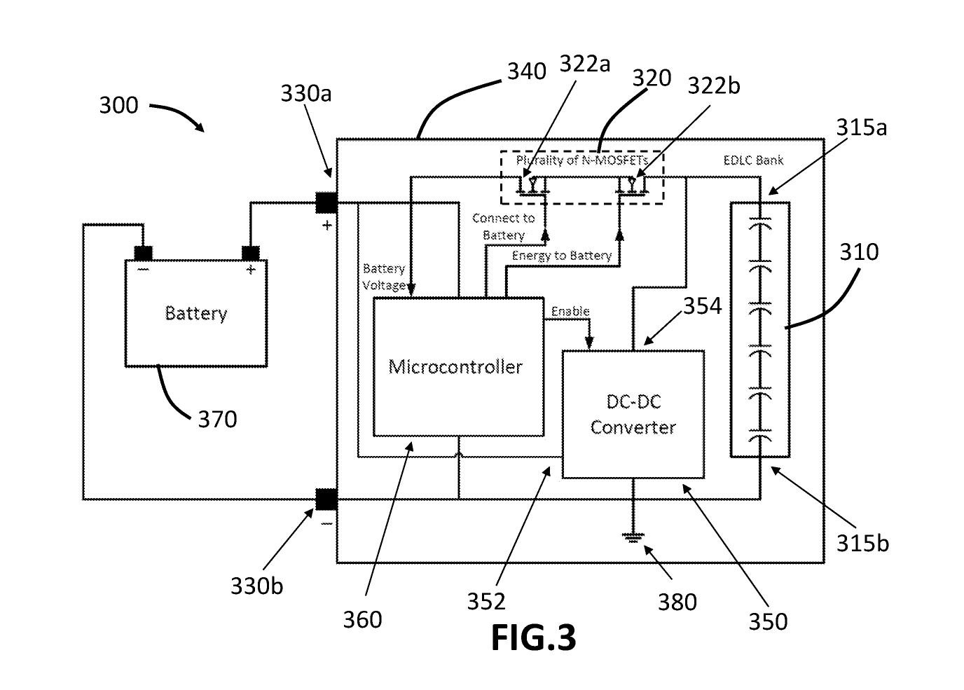

In some embodiments, an additional controller (not shown) can be included within the housing 240, and this additional controller is in communication with the external controller 250 to control the operation of the safety switch 220 (see, e.g., FIG. 3).

In some embodiments, the controller 250 is configured to actuate the safety switch 220 to disconnect the ultracapacitor cell 210 from the terminal 230a in response to an overcharge condition of the ultracapacitor cell 210. In some embodiments, any other internal/external fault can also trigger the controller 250 to disengage the safety switch 220.

In some embodiments, the system 200 also includes a sensor (not shown), operably coupled to the controller 250, to measure the ambient temperature around the ultracapacitor cell 210. The controller 250 is configured to actuate the safety switch 220 to disconnect the ultracapacitor cell 210 from the terminal 230a in response to the ambient temperature being greater than a threshold value. In some embodiments, the sensor is configured to measure the internal housing temperature, and the controller 250 is configured to actuate the safety switch 220 to disconnect the ultracapacitor cell 210 from the terminal 230a response to the internal housing temperature being greater than a threshold value.

FIG. 3 is a schematic illustration of an ultracapacitor system 300 including a safety switch 320 controlled by a microcontroller 360 in accordance with some embodiments. The system 300 includes a series of ultracapacitors 310 enclosed by a housing 340. Two terminals 330a and 330b operably coupled to the series of ultracapacitors 310 are disposed external to the housing 340 (e.g., on the exterior surface of the housing 340) and electrically coupleable to the bank of the ultracapacitors 310 via the switch 320. More specifically, the bank of the ultracapacitor 310 has a first side 315a electrically coupled to the positive terminal 330a via the switch 320, and the bank has a second side 315b directly coupled to the negative terminal 330b.

A power supply or battery 370 is connected to the two terminals 330a and 330b, and a DC-DC converter 350 is also enclosed within the housing to facilitate the energy transfer between the ultracapacitors 310 and the power supply or battery 370. The DC-DC converter 350 can have an input 352 electrically coupled to the positive terminal 330a, which is electrically coupled to the power supply or battery 370. The DC-DC converter 350 also has an output 354 electrically coupled to the first side 315a of the bank of the ultracapacitor 310. In addition, the negative terminal 330b, the microcontroller 360, the DC-DC converter 350, and the second side 315b of the bank of the ultracapacitor 310 can be connected to a common ground 380. The switch 320 includes a pair of MOSFETs 322a and 322b to allow bi-directional switching between the ultracapacitor 310 and the power supply or battery 370. For example, turning off one MOSFET (connecting the gate of the MOSFET to the source, i.e., V_{g}s=0) can block current flow from the power supply or battery 370 to the ultracapacitors 310, and turning off another MOSFET (e.g., 322b) can block current flow from the ultracapacitors 310 to the power supply or battery 370. In some embodiments, the microcontroller 360 is further controlled by an external device (e.g., a controller) or an operator via wireless communication. In these embodiments, the microcontroller 360 may still automatically disconnect the switch 320 in response to, for example, internal/external fault conditions so as to provide enhanced safety.

As shown in FIG. 3, the ultracapacitor 310, the switch 320, the DC-DC converter 350, and the microcontroller 360 can be all enclosed in the housing 340 so as to provide an integrated energy module with enhanced safety features. The housing 340 can be sealed such that only authorized personnel (e.g., maintenance personal from manufacturer) can open the housing 340 and disable the switch 320. In other words, end users may not have the option to open the housing 340 and/or disable the switch 320.

In some embodiments, the microcontroller 360 is powered by the ultracapacitors 310. In some embodiments, the microcontroller 360 is powered by the power supply or battery 370. In some embodiments, the microcontroller 360 can be powered by an external power source via, for example, wireless energy transfer.

In some embodiments, the DC-DC converter 350 can receive energy from the power supply or battery 370 so as to charge the ultracapacitor 310. The DC-DC converter 350 is also operably coupled to the microcontroller 360, which can provide control signals to the DC-DC converter 350 so as to control the charging process. In some embodiments, the microcontroller 360 can control the DC-DC converter 350 to only charge the ultracapacitor 310 and not to charge the power supply or battery 370 (i.e., one-way energy transfer from power supply or battery 370 to the ultracapacitor 310). In some embodiments, the microcontroller 360 can control the charging rate based on the status of the power supply or battery 370.

In some embodiments, the microcontroller 360 is configured to turn off the switch 320 to prevent the ultracapacitors 310 from accepting any energy when the power supply or battery 370 is not connected. In some embodiments, the microcontroller 360 is configured to turn off the switch 320 if a fault is detected. In some embodiments, the fault includes an internal fault, such as an overcharge condition. In some embodiments, the internal fault includes a DC-DC charger 350 malfunction or a microcontroller 360 malfunction.

In some embodiments, the fault includes an external fault, such as am ambient temperature higher than a threshold value. In some embodiments, the external fault is an over current condition caused by an external short circuit, an overvoltage applied to terminals 330a and 330b, a reverse bias voltage applied to terminals 330a and 330b, or invalid control input.

In some embodiments, the system 300 includes a serial string of ultracapacitors 310, each of which can be high specific capacitance electrochemical capacitor that stores energy electrostatically. A typical ultracapacitor 310 has a capacitance value that is about 10,000 times that of an electrolytic capacitor, an energy density approximately 10% that of a conventional battery, and a power density up to 100 times that of the battery. This allows for a faster charge and discharge cycles for ultra-capacitors 310 compared to conventional batteries. It can also give the ultracapacitors 310 extremely long cycle lives compared to batteries.

Each ultracapacitor 310 can be charged to a predetermined level of per cell voltage. As a specific example, the ultracapacitors 310 may be charged to support 2.7 V/cell. The per-cell voltage value may be shifted automatically higher (e.g., 3.0 V/cell) when a low temperature is reached (e.g., 0° F.) and even higher per-cell voltage (e.g., 3.3 V/cell) when the temperature falls even lower (e.g., below −20° F.). In some embodiments, the temperature may be measured by a sensor (not shown in FIG. 3). In some embodiments, each pack of ultracapacitors 310 may use a DC-DC converter (e.g., a 500 W DC-DC converter) 350 that can be settable in a factory to a voltage range, e.g., from 16.2 V to 24 V. The DC-DC converter 350 may have either a boost or single-ended primary inductor converter (SEPIC) topography. Additionals details can be found in U.S. Patent Publication No. 2016/0243960A1 and entitled “ENGINE START AND BATTERY SUPPORT MODULE,” the disclosure of which is incorporated by reference herein in its entirety.

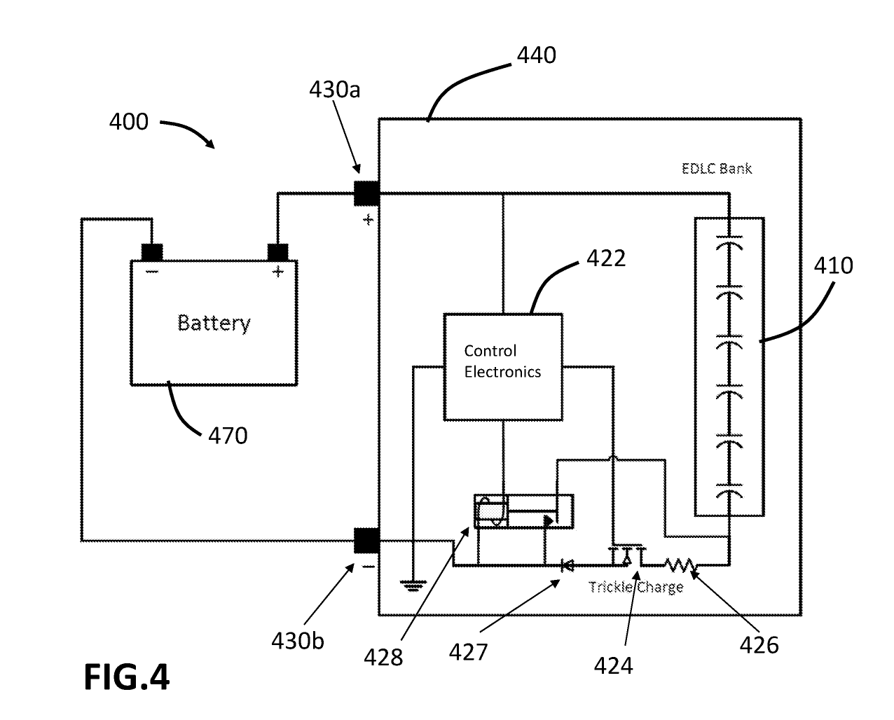

FIG. 4 is a schematic illustration of a ultracapacitor system 400 including control electronics 422 and a trickle charge switch 424 to allow trickle charging, i.e. charging at a slow rate or charging under no-load at a rate equal to its self-discharge rate. The system 400 includes a series of ultracapacitors 410 enclosed in a housing 440, and the ultracapacitors 410 have two terminals 430a and 430b disposed on an exterior surface of the housing 440. Control electronics 422 includes voltage controlled switches which enable and disable the safety switch 428 and trickle charge switch 424. In some embodiments, safety switch 428 is electromechanical relay. A power supply or battery 470 can be operably connected to the two terminals 430a and 430b. The safety switch 428 is operably coupled to the ultracapacitors 410 and the power supply or battery 470. In operation, turning off the safety switch 428 disconnects the ultracapacitors 410 from terminal 430b (and accordingly the operable connection to the power supply or battery 470) so as to render the energy storage device electrically safe.

The trickle charging switch 424 is actuated by the control electronics 422 to allow charging of the ultracapacitors 410 from the power supply or battery 470, so that safety switch 428 can engage when a voltage is at or equal to a predetermined threshold prevent a current surge. The trickle charge switch 424 includes a diode 427 to block reverse voltage and a MOSFET that is actuated when both the power supply (e.g., battery 470) and the ultracapacitors 410 are coupled. The trickle charging continues until the voltage differential between ultracapacitors 410 and battery 470 converge and the safety switch 428 engages. A resistor 426 can also be included in the ultracapacitor system 400 to regulate the current flow during trickle charging.

While the present disclosure has primarily been described in terms of ultracapacityors, various other types of energy storage devices may benefit from a safety switch, including, but not limited to, conventional capacitors, electrochemical batteries, and fuel cells in accordance with some embodiments.

Conventional capacitors generally include two conducting electrodes (also referred to as capacitor banks) separated by an insulating dielectric material (e.g., air or other dielectric materials). When a voltage is applied to a capacitor, positive electric charges accumulate on the surface of one electrode and negative electric charges accumulate on the surface of the other electrode. The insulating dielectric material separates the positive charges from the negative charges, thereby producing an electric field that allows the capacitor to store energy.

Capacitance C of a capacitor is defined as C=Q/V, where Q is the stored charge and V is the applied voltage. In general, a high capacitance allows a capacitor to store more energy given the same voltage applied over the capacitor. For conventional capacitors, the capacitance C can be defined as C=ε₀εᵣA/D, where A is the surface area of each electrode, D is the distance between the electrodes, ε₀ is the dielectric constant (or “permittivity”) of free space and εᵣ is the dielectric constant of the insulating material between the electrodes.

The energy storage and discharge ability of a capacitor is characterized by its energy density and power density, which can be calculated as the total energy or power divided by the mass or volume of the capacitor. The total energy E stored in a capacitor can be calculated as E=1/2CV², which is proportional to the capacitor C. The power P of a capacitor is generally the energy expended per unit time. To determine P for a capacitor, capacitors can be regarded as a circuit in series with an external “load” resistance R. The internal components of the capacitor (e.g., current collectors, electrodes, and dielectric material) also contribute to the resistance, which can be collectively measured by the equivalent series resistance (ESR) of the capacitor. When measured at matched impedance (R=ESR), the maximum power Pₘₐₓ for a capacitor can be calculated by Pₘₐₓ=V²/(4ESR), showing that the ESR can be a limiting factor to the maximum power (and therefore maximum power density) of a capacitor.

Compared to electrochemical batteries and fuel cells, conventional capacitors can have higher power densities, but lower energy densities. In other words, a battery can store more total energy, but takes a longer time to deliver the energy and charge the battery. A capacitor, on the other hand, may store less energy per unit mass or volume, but discharges the energy rapidly to produce a lot of power.

To address the shortcomings of conventional capacitors (low energy density) and batteries (low power density), ultracapacitors use electrodes with large surface areas A (e.g., porous electrodes) and a short distance D (e.g., less than 1 μm or even 1 nm) between the capacitor banks. Large surface area can result in larger capacitance so as to increase the energy density of the ultracapacitor, while the short distance between capacitor banks can result in lower ESR and therefore increase the power density of the ultracapacitor. In addition, ultracapacitors can have several other advantages over electrochemical batteries and fuel cells, including higher power density, shorter charging times, and longer cycle life and shelf life. However, as introduced above, ultracapacitors can also pose increased safety hazards to operators, and it is desirable to provide feasible and efficient safety measures when ultracapacitors are used.

Referring back to FIGS. 1 and 2, in some embodiments, the ultracapacitor cell 110 shown in FIG. 1 (or ultracapacitor cell 210 in FIG. 2) includes an electrochemical double-layer capacitor (EDLC). In general, EDLCs store charge electrostatically (also referred to as non-Faradaic storage) and there is no charge transfer between the internal electrodes 112, 114 (or internal electrodes 212 and 214 in FIG. 2) and the electrolyte 115 (or electrolyte 215 in FIG. 2). More specifically, EDLCs can utilize an electrochemical double-layer of charge to store energy. When a voltage is applied over an EDLC, positive ions in the electrolyte 115 diffuse across the separator 116 toward the negative electrode 114, while negative ions or electros in the electrolyte 115 drift toward the positive electrode 112. In addition, the internal electrodes 112, 114 are manufactured such that there is no recombination of the charges. Thus, a double-layer of charge can be produced at each electrode. The combination of double-layers, increased surface area of internal electrodes 112,114, and a decreased distance between internal electrodes 112,114, allows EDLCs to achieve higher energy densities compared to conventional capacitors. Because there can be no chemical or composition changes associated with non-Faradaic processes at the internal electrodes 112, 114, charge storage in EDLCs is highly reversible, thereby allowing high cycling stabilities. For example, EDLCs can generally operate with stable performance characteristics for as many as 10⁶ cycles.

The internal electrodes 112, 114 may comprise various materials. In some embodiments, the internal electrodes 112, 114 include one or more carbon-based materials, which have the advantages of relatively high surface area, low cost, and well-established fabrication techniques.

In some embodiments, the internal electrodes 112,114 include activated carbon with a porous structure. The activated carbon may include micropores with a characteristic diameter of less than about 2 nm. In some embodiments, the activated carbon includes mesopores with a characteristic diameter of less than about 50 nm. In other embodiments, the activated carbon includes macropores with a characteristic diameter greater than about 50 nm. The activated carbon may include a combination of micropores, mesopores, and/or macropores. In general, larger pore sizes may result in higher power densities, while smaller pore sizes may produce higher energy densities. Therefore, in practice, the distribution of pore sizes and the distribution of activated carbon electrodes may depend on the desired energy density or power density of the resulting ultracapacitor.

In some embodiments, the internal electrodes 112, 114 include carbon aerogels, which can be formed from a continuous network of conductive carbon nanoparticles with interspersed mesopores. Due to the continuous structure and ability of carbon aerogels to chemically bond to current collectors (not shown in FIG. 1), carbon aerogels normally do not require additional adhesive binding agent in applications. As a result, electrodes made of carbon aerogels may have a lower ESR compared to activated carbons and accordingly higher power density.

In some embodiments, the internal electrodes 112, 114 include carbon nanotubes (CNTs). Internal electrodes 112, 114 in these examples can be grown as an entangled mat of CNTs, with an open and accessible network of mesopores. Unlike other carbon-based electrodes, the mesopores in carbon nanotube electrodes can be interconnected, thereby allowing a continuous charge distribution that can utilize nearly all the available surface area of the internal electrodes 112, 114. Therefore, the effective surface area of the internal electrodes 112, 114 can be further increased, thereby increasing the capacitance of the resulting ultracapacitor. In addition, because ions can more easily diffuse into the mesoporous network, carbon nanotube electrodes can also have a lower ESR compared to activated carbon. In some embodiments, the nanotubes used in the internal electrodes 112, 114 include single-walled CNTs, which have relatively high electrical conductivity and a potentially larger voltage window of stability.

In some embodiments, CNTs are grown directly onto the current collectors so as to form the internal electrodes 112, 114. In some embodiments, CNTs are cast into colloidal suspension thin films, which can then be transferred to current collectors so as to form the internal electrodes 112, 114.

In some embodiments, the internal electrodes 112, 114 include graphene. The graphene may be synthesized by chemical reduction of graphene oxide using hydrazine. Graphene can have relatively higher accessible surface areas (e.g., about 2600 m²/g due to lack of agglomeration), high conductivity (e.g., about 100 S/m), and excellent chemical stability. In some embodiments, the internal electrodes 112, 114 include conducting polymers.

In some embodiments, the internal electrodes 112, 114 include transition metal oxides, which can have layered structures and adopt wide variety of oxidation states. Electrochemical behavior of oxides can be pseudo-capacitive in nature due to highly reversible surface chemical reactions and/or extremely fast and reversible lattice intercalation. In some embodiments, the internal electrodes 112, 114 include a ruthenium oxide and/or a manganese oxide.

In some embodiments, the internal electrodes 112, 114 include a composite of transition metal oxides and/or other electrode materials, such as conducting polymers and/or carbon-based materials to retain performance while reducing manufacturing cost. In some embodiments, the internal electrodes 112, 114 include ruthenium dioxide, which can be electrodeposited into poly (3,4-ethylenedioxythiophene). In some embodiments, the internal electrodes 112, 114 include a manganese oxide deposited onto CNTs and a conducting polymer such as polypyrrole to increase the conductivity.

In some embodiments, the internal electrodes 112, 114 include a nitride and/or sulfide, such as molybdenum nitride. In some embodiments, a nitride is synthesized by temperature programmed nitridation of various oxides, such as molybdenum and/or vanadium. In some embodiments, the internal electrodes 112, 114 include vanadium nitride (VN) nanoparticles synthesized by a two-step ammonolysis method followed by passivation. In some embodiments, the internal electrodes 112, 114 include copper and cobalt sulfide films.

The electrolyte 115 in the ultracapacitor cell 110 may include various materials. In some embodiments, the electrolyte 115 includes an aqueous electrolyte, such as sulfuric acid (H₂SO₄) and/or potassium hydroxide (KOH). In some embodiments, the electrolyte 115 includes an organic electrolyte, such as acetonitrile. In some embodiments, the electrolyte 115 includes etraethyl ammonium tetraflouroborate (Et₄NBF₄) in acetonitrile. In some embodiments, the electrolyte 115 includes polyaniline electrodes in organic acid (CF₃COOH) with a supporting electrolyte of tetramethyl ammonium methanesulfonate. Aqueous electrolytes may have lower ESR and lower minimum pore size requirements compared to organic electrolytes. However, aqueous electrolytes also may have lower breakdown voltages. In practice, tradeoffs between capacitance, ESR, and voltage may be taken into account when selecting the electrolyte.

The separator 116 in the ultracapacitor cell 110 allows passage of ions but not electrons so as to avoid direct discharge between the internal electrodes 112, 114. In some embodiments, the separator 116 includes a membrane which may be composed of a synthetic polymer with ionic properties (i.e., an ionomer), such as a Nafion® PFSA membrane (available from DuPont Co. (Wilmington, Del.)), which may include a hydrophobic Teflon™ backbone and side chains and hydrophilic sulfonic acid (—SO₃H) groups. In some embodiments, the separator 116 includes polyvinyl alcohol, which has relatively good mechanical strength and lower cost. In some embodiments, the separator 116 includes lauroyl chitosan, which has relatively high levels of mechanical strength and ionic liquid retention.

In some embodiments, the separator 116 is prepared from the resulting mixture of hybrid polymer electrolyte polyvinyl alcohol (PVA) (e.g., about 70%) and phosphoric acid (H₃PO₄) (e.g., about 30%) immersed in the solution of the combination of polymethyl (methacrylate) and lauroyl chitosan (PLC), for ultracapacitor application. In some embodiments, the separator 116 is made from polypropylene.

In some embodiments, the ultracapacitor 110 includes a pseudo-capacitor. In general, pseudo-capacitors store charge via a Faradaic process including transfer of charge between the internal electrodes 112,114 and the electrolyte 115. The charge transfer may be achieved through, for example, electrosorption, reduction-oxidation reactions, and/or intercalation processes, among others. These Faradaic processes may allow pseudo-capacitors to achieve higher capacitances and energy densities.

In some embodiments, the internal electrodes 112, 114 used in pseudo-capacitors include conducting polymers, which can have high capacitance and conductivity, in addition to a low ESR and cost. In some embodiments, the internal electrodes 112, 114 have an n/p-type polymer configuration, in which the negative electrode 114 includes a negatively charged (n-doped) conductive polymer and the positive electrode 112 includes a positively charged (p-doped) conducting polymer.

In some embodiments, the internal electrodes 112, 114 in pseudo-capacitors include a metal oxide such as ruthenium oxide due to its high capacitance. The capacitance of ruthenium oxide can be achieved through the insertion and removal, or intercalation, of protons into its amorphous structure. In its hydrous form, ruthenium oxide can have a capacitance greater than that of carbon-based and conducting polymer materials. Furthermore, the ESR of hydrous ruthenium oxide can be lower compared to other electrode materials.

In some embodiments, the internal electrodes 112, 114 include nanoparticles. In some embodiments, mesoporosity and crystallinity may be retained in nanoparticles to obtain maximum pseudo-capacitance. Improvements in charge storage capacity can depend on the porosity of the external walls. The mesoporosity and resulting nanoparticulate nature may produce large surface and easy intercalation. At the same time, crystallinity may be maintained to reduce grain boundaries and the associated mass transfer effects. In some embodiments, the internal electrodes 112, 114 include TiO₂ or MoO₃ synthesized by template methods. Compared with sol-gel derived materials, template-synthesized materials can have more developed and ordered pores, thereby allowing easy diffusion of electrolyte into inner pores and producing increased capacitance and intercalation.

In some embodiments, the ultracapacitor cell 110 includes a hybrid capacitor that can utilize both Faradaic and non-Faradaic processes to store charge. Hybrid capacitors may achieve high energy and power densities without sacrificing cycling stability and affordability.

In some embodiments, the internal electrodes 112, 114 include composite electrodes so as to form hybrid capacitors. Composite electrodes may include carbon-based materials with conducting polymers and/or metal oxide materials. The carbon-based materials can facilitate the formation of a capacitive double-layer of charge and provide a high-surface-area backbone that increases the contact between the deposited pseudo-capacitive materials and electrolyte 115. The pseudo-capacitive materials can further increase the capacitance of the composite electrode through Faradaic reactions.

In some embodiments, the internal electrodes 112, 114 include composite electrodes constructed from carbon nanotubes and a conducting polymer (e.g., polypyrrole). This combination can have higher capacitances compared to either a pure carbon nanotube-based electrode or a pure polypyrrole polymer-based electrode.

In some embodiments, the ultracapacitor cell 110 includes an asymmetric configuration, which combines Faradaic and non-Faradaic processes by coupling an EDLC electrode with a pseudo-capacitor electrode. The negative electrode 114 may include an activated carbon electrode, and/or the positive electrode 112 may include a conducting polymer electrode.

In some embodiments, the ultracapacitor 110 includes a battery-type configuration that couples two different types of electrodes in a single ultracapacitor cell. Battery-type hybrid capacitors generally include a ultracapacitor electrode with a battery electrode. In some embodiments, the battery electrode includes nickel hydroxide, lead dioxide, and/or lithium titanate (e.g., Li₄Ti₅O₁₂), among others. In some embodiments, the ultracapacitor electrode includes activated carbon or any other materials described herein.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, while the embodiments herein describe electrochemical devices such as, for example, lithium ion batteries, the systems, methods, and principles described herein are applicable to all devices containing electrochemically active media. Any electrodes and/or devices including at least an active material (source or sink of charge carriers), an electrically conducting additive, and an ionically conducting media (electrolyte) such as, for example, batteries, capacitors, electric double-layer capacitors (e.g., ultracapacitors), pseudo-capacitors, etc., are within the scope of this disclosure. Furthermore, embodiments may be used with non-aqueous and/or aqueous electrolyte battery chemistries.

In another example, embodiments may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes (e.g., of designing and making the retention/delivery structure disclosed above) outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system comprising:
an energy storage device substantially enclosed in a housing;
a first terminal and a second terminal for electrically coupling the energy storage device with an external device, the first terminal and the second terminal being external to the housing; and
a switch device substantially enclosed within the housing for controlling the electrical connection between the energy storage device and at least one of the first terminal and the second terminal, the switch device being operably disposed between the energy storage device and at least one of the first terminal and the second terminal.

2. The system of claim 1, wherein the energy storage device comprises one or more of a supercapacitor, an EDLC, and an ultracapacitor.

3. The system of claim 1, wherein the electrical energy storage device comprises a battery.

4. The system of claim 1, wherein the switch device is solid state.

5. The system of claim 1, wherein the switch device comprises a metal-oxide-semiconductor field-effect transistor (MOSFET).

6. The system of claim 1, wherein the switch device substantially enclosed within the housing does not include an external actuator to disconnect the electrical connection between the energy storage device and at least one of the first terminal and the second terminal.

7. The system of claim 1, further comprising:
a controller operably coupled to the switch device for controlling the switch device.

8. The system of claim 7, wherein the controller is substantially enclosed in the housing.

9. The system of claim 7, wherein the controller is operably coupled to the switch device via one or more of wired communication and wireless communication.

10. The system of claim 7, wherein the switch device is configured to be actuated only in response to a wireless control signal.

11. The system of claim 7, wherein the controller is operably coupled to the switch via Bluetooth communication.

12. The system of claim 11, wherein the controller is further configured to receive status information about the energy storage device via the Bluetooth communication.

13. The system of claim 7, wherein the controller is configured to actuate the switch device to disconnect the energy storage device from the at least one of the first terminal and the second terminal in response to an overcharge condition of the energy storage device.

14. The system of claim 7, further comprising:
at least one sensor, operably coupled to the controller, to measure an ambient temperature around the energy storage device, wherein the controller is configured to actuate the switch device to disconnect the energy storage device from the at least one of the first terminal and the second terminal in response to the ambient temperature being greater than a threshold value.

15. The system of claim 7, further comprising:
at least one sensor, operably coupled to the controller, to measure an internal housing temperature, wherein the controller is configured to actuate the switch device to disconnect the energy storage device from the at least one of the first terminal and the second terminal in response to the internal housing temperature being greater than a threshold value.

16. The system of claim 1, wherein the energy storage device comprises an ultracapacitor and the external device includes a battery.

17. The system of claim 16, further comprising:
a DC-DC converter operably coupled to the ultracapacitor and the battery configured to facilitate energy transfer between the battery and the ultracapacitor.

18. The system of claim 16, wherein the switch device includes two or more MOSFETs.

19. The system of claim 16, further comprising:
a controller operably coupled to the switch device for controlling the switch device, the controller configured to selectively actuate the switch device to disconnect the energy storage device from the at least one of the first terminal and the second terminal.

20. The system of claim 16, wherein the controller is powered by at least one of the ultracapacitor or the energy storage device.

21. The system of claim 16, further comprising:
a trickle charge switch, the trickle charge switch electrically coupled to the ultracapacitor and the battery and configured to charge the ultracapacitor to a predetermined threshold.

22. The system of claim 21, wherein the trickle charge switch includes a MOSFET.

23. A method of operating a system comprising an energy storage device including a housing, a first terminal, and a second terminal for electrically coupling the energy storage device with an external device, and a switch device substantially enclosed within the housing and operably disposed between the energy storage device and at least one of the first terminal and the second terminal, the method comprising actuating the switch device to cause at least one of:
disconnecting the energy storage device from at least one of the first terminal and the second terminal so as to prevent at least one of providing energy to the external device from the energy storage device and charging the energy storage device with energy from the external device; and
connecting the energy storage device to at least one of the first terminal and the second terminal so as to enable at least one of providing energy to the external device from the energy storage device and charging the energy storage device with energy from the external device.

24. The method of claim 23, wherein the energy storage device comprises one or more of a supercapacitor, an EDLC, and an ultracapacitor.

25. The method of claim 23, wherein the electrical energy storage device comprises a battery.

26. The method of claim 23, wherein the switch device is solid state

27. The method of claim 23, wherein the switch device comprises a metal-oxide-semiconductor field-effect transistor (MOSFET).

28. The method of claim 23, further comprising:
a controller operably coupled to the switch device for controlling the switch device.

29. The method of claim 28, wherein the controller is substantially enclosed within the housing.

30. The method of claim 28, wherein the controller is operably coupled to the switch device via one or more of wired communication and wireless communication.

31. The method of claim 28, wherein the controller is operably coupled to the switch via Bluetooth communication.

32. The method of claim 31, wherein the controller is further configured to receive status information about the energy storage device via the Bluetooth communication.

33. The method of claim 28, wherein the controller is configured to actuate the switch device to disconnect the energy storage device from the at least one of the first terminal and the second terminal in response to an overcharge condition of the energy storage device.

34. The method of claim 28, wherein the controller is configured to actuate the switch device to disconnect the energy storage device from at least one of the first terminal and the second terminal in response to an ambient temperature being greater than a threshold value.

35. The method of claim 28, wherein the controller is configured to actuate the switch device to disconnect the energy storage device from at least one of the first terminal and the second terminal in response to an internal housing temperature being greater than a threshold value.

36. A method of operating a system comprising an energy storage device including a housing, a first terminal and a second terminal configure to electrically coupled to the energy storage device, and a switch device substantially enclosed within the housing and operably disposed between the energy storage device and at least one of the first terminal and the second terminal, the method comprising:
electrically coupling the first terminal and the second terminal to an external device so as to at least one of provide energy to external device from the energy storage device and charge the energy storage device with energy from the external device; and
actuating the switch device to disconnect the energy storage device from the at least one of the first terminal and the second terminal so as to render the energy storage device electrically safe.
